(19) United States
(12) Patent Application Publication
(10) Pub. No.: US 2026/0169142 A1
(43) Pub. Date: Jun. 18, 2026

(54) SONAR SYSTEM WITH DAS SENSING PANELS AND RELATED WATERCRAFT AND RELATED METHOD

(71) Applicant: EAGLE TECHNOLOGY, LLC, MELBOURNE, FL (US)

(72) Inventors: JOSEPH A. CICHOCK, INDIALANTIC, FL (US); JASON LAPORTE, GOLETA, CA (US); JOHN T. GALLO, JACKSONVILLE, FL (US); CHAD CHUNG LAU, MELBOURNE, FL (US); JOAO PEDRO PEREIRA, PALM BAY, FL (US); SONJA FROHOCK, PALM BAY, FL (US)

(21) Appl. No.: 18/980,659

(22) Filed: Dec. 13, 2024

(51) Int. Cl. G01S 7/521; G01S 15/04; G01S 15/06; G01S 15/42; G01S 15/87; G01S 15/89; G01S 15/96

(52) U.S. Cl. CPC G01S 7/521; G01S 15/04; G01S 15/06; G01S 15/42; G01S 15/87; G01S 15/89; G01S 15/96

(57) ABSTRACT

Generally, a sonar system is for a watercraft. The sonar system may include a DAS sensing panel for an exterior of the watercraft, and an array of fiber optic DAS sensors carried by the DAS sensing panel and coupled together in a daisy chain configuration. Each fiber optic DAS sensor may include a mandrel and an optical fiber wound thereon. The sonar system may also include a DAS sonar device, and an optical fiber cable for coupling a first fiber optic DAS sensor and the DAS sonar device through a hull penetration in the watercraft.

### TECHNICAL FIELD

The present disclosure relates to the field of sensing, and, more particularly, to sonar devices and related methods.

### BACKGROUND

Remote sensing applications have a wide range of applications. One particular type of sensing is acoustic signal sensing. Broadly, acoustic signals are mechanical waves in gases, liquids, and solids. For example, in security, a person trespassing on private property creates acoustic waves that propagate through the ground. Similarly, seismic events, such as earthquakes, create powerful acoustic waves in the ground that can be detected at far distances from the source. Also, in underwater applications, submerged objects can create acoustic waves within the body of water.

One advantageous type of remote acoustic sensing is distributed acoustic sensing (DAS). In this approach, optical fibers are positioned in the area or structure to be monitored, and this approach is based upon, for example, Rayleigh backscattering. Here, a coherent laser pulse is sent along an optical fiber, and scattering sites within the optical fiber cause the optical fiber to function as a distributed interferometer. The reflected light is coherently combined with a reference pulse, and the detected phase change is measured as a function of time after transmission of the laser pulse. This is known as phase-sensitive optical time domain reflectometry. When an acoustic signal is present, the reflected optical signals phase changes proportionally to the received acoustic signal.

In underwater applications, acoustic sensing devices (i.e., sonar devices) are placed on watercraft to monitor sound created by underwater objects. For example, sonar devices may be used to locate underwater creatures for observation and sport. In some applications, underwater sonar may be used for locating rogue objects and rogue vehicles underwater. One approach to sonar underwater sensing is hull mounted sonar sensing processing systems. These approaches may have some drawbacks, such as complex manufacturing.

### SUMMARY

Generally, a sonar system is for a watercraft. The sonar system may include at least one DAS sensing panel for an exterior of the watercraft, and an array of fiber optic DAS sensors carried by the at least one DAS sensing panel and coupled together in a daisy chain configuration. Each fiber optic DAS sensor may include a mandrel and an optical fiber wound thereon. The sonar system includes a DAS sonar device, and an optical fiber cable for coupling a first fiber optic DAS sensor and the DAS sonar device through a hull penetration in the watercraft.

In some embodiments, the at least one DAS sensing panel may include a plurality of DAS sensing panels. The array of fiber optic DAS sensors may comprise a plurality of arrays of fiber optic DAS sensors respectively carried by the plurality of DAS sensing panels.

The at least one DAS sensing panel may have a curved shape conformal with adjacent portions of the watercraft. The sonar system may also include a potting compound over the array of fiber optic DAS sensors. The array of fiber optic DAS sensors may comprise at least two columns and at least two rows of DAS sensors. More specifically, the DAS sonar device may comprise an optical source, an optical detector, and a processor coupled to the optical source and optical detector. Also, the DAS sonar device may be entirely within the watercraft, and the at least one DAS sensing panel may not include a pressure vessel.

Another aspect is directed to a watercraft comprising a hull, and a sonar system carried by the hull and comprising at least one DAS sensing panel for an exterior of the hull. The sonar system may also include an array of fiber optic DAS sensors carried by the at least one DAS sensing panel and coupled together in a daisy chain configuration. Each fiber optic DAS sensor may comprise a mandrel and an optical fiber wound thereon. The sonar system may also include a DAS sonar device, and an optical fiber cable for coupling a first fiber optic DAS sensor and the DAS sonar device through a hull penetration in the hull.

Yet another aspect is directed to a method for installing a sonar system in a watercraft. The method may comprise positioning at least one DAS sensing panel on an exterior of a hull, and positioning an array of fiber optic DAS sensors to be carried by the at least one DAS sensing panel and coupled together in a daisy chain configuration. Each fiber optic DAS sensor may include a mandrel and an optical fiber wound thereon. The method may further include coupling an optical fiber cable through a hull penetration in the hull and between a first fiber optic DAS sensor and a DAS sonar device.

### BRIEF DESCRIPTION OF THE DRAWINGS

FIG. 1 is a schematic diagram of a DAS sensor sonar system, according to a first example embodiment of the present disclosure.

FIG. 2 is a schematic diagram of a DAS sensing panel from the DAS sensor sonar system of FIG. 1.

FIG. 3 is a schematic diagram of fiber optic DAS sensors in the DAS sensing panel from the DAS sensor sonar system of FIG. 1.

FIG. 4 is a schematic diagram of a DAS sensing panel, according to a second example embodiment of the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

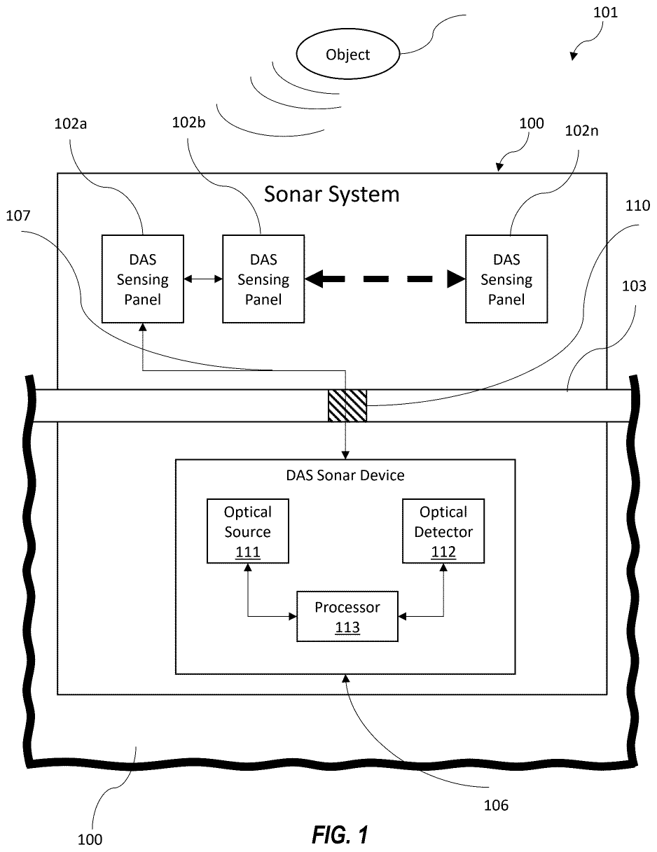

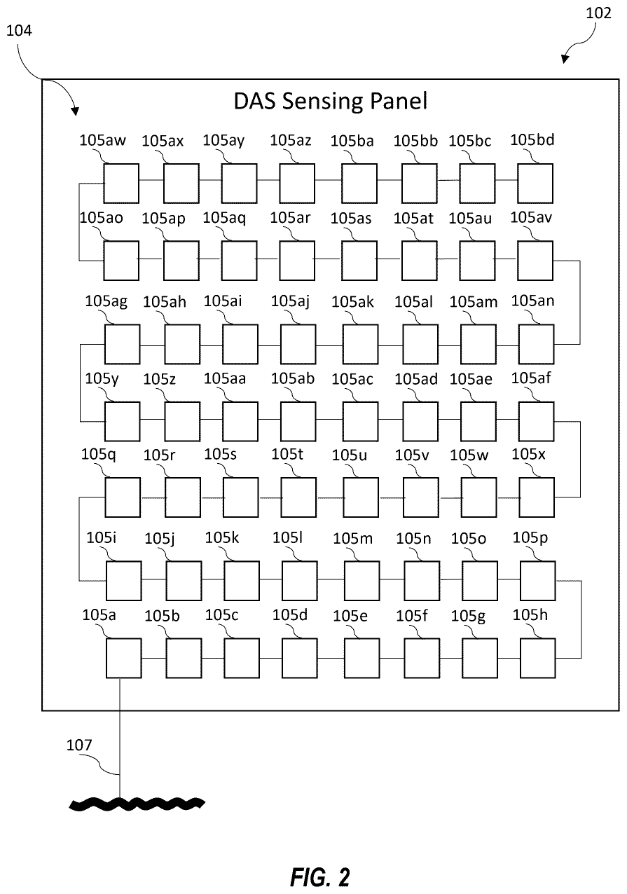

Referring to FIGS. 1-2, a DAS sensor sonar system 100 is for a watercraft 101, and may be used to detect an object 117 underwater. The DAS sensor sonar system 100 illustratively includes a plurality of DAS sensing panels 102a-102n for an exterior of the watercraft 101. In particular, in this exemplary embodiment, the plurality of DAS sensing panels 102a-102nis carried by a hull 103 of the watercraft 101. Further, although three DAS sensing panels 102a-102n are shown, it should be appreciated that the number of DAS sensing panels may be more or less depending on the application and the size of the watercraft 101.

As perhaps best seen in FIG. 2, the DAS sensor sonar system 100 illustratively includes a plurality of arrays 104 of fiber optic DAS sensors 105a-105bd carried respectively by the plurality of DAS sensing panels 102a-102n and coupled together in a daisy chain configuration. Only one of the plurality of arrays 104 is depicted, but it should be appreciated that the other arrays are similarly constituted. The DAS sensor sonar system 100 illustratively includes a DAS sonar device 106, and an optical fiber cable 107 (e.g., coated optical fiber, 8 μm core single mode optical fiber) for coupling a first fiber optic DAS sensor 105a and the DAS sonar device through a single hull penetration 110 in the hull 103 of the watercraft 101. Each array 104 of fiber optic DAS sensors 105a-105bd illustratively includes eight columns and seven rows of DAS sensors 105a-105bd. Of course, this array size is merely exemplary and can grow or shrink in size, or change in overall shape depending on the application.

More specifically, the DAS sonar device 106 illustratively includes an optical source 111 (e.g., an optical laser), an optical detector 112, and a processor 113 coupled to the optical source and optical detector. Also, the DAS sonar device 106 may be entirely within the watercraft 101, and the plurality of DAS sensing panels 102a-102n may not include a pressure vessel. In the illustrated embodiment, the single optical source 111 is configured to support all of the plurality of DAS sensing panels 102a-102n, requiring a single hull penetration 110.

In other embodiments, each DAS sensing panels 102a-102n may be operated based upon an optical source, or a subset of DAS sensing panels may be operated based upon an optical source. In these embodiments, there may also be a single hull penetration 110 or perhaps more than one if the DAS sensing panels 102a-102n are spaced apart far enough to make running the optical fiber cable 107 along the hull 103 undesirable.

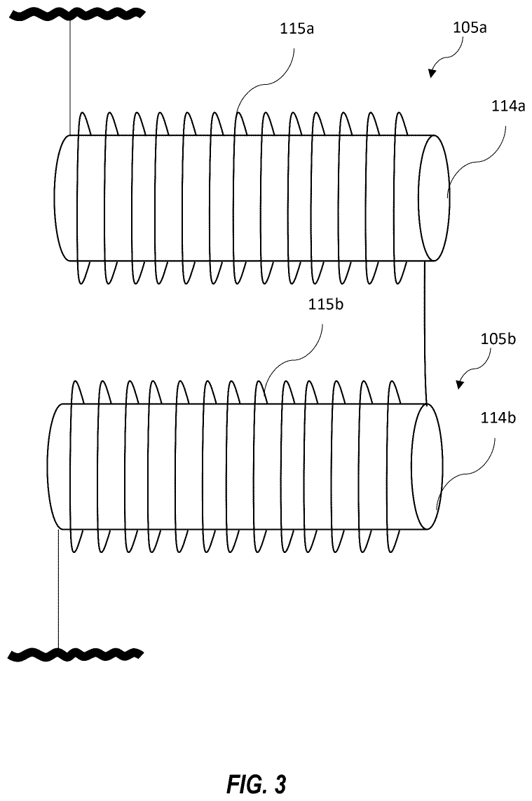

Referring now additionally to FIG. 3, each fiber optic DAS sensor 105a-105b illustratively comprises a mandrel 114a-114b and an optical fiber wound 115a-115b thereon. For drawing simplicity, only two fiber optic DAS sensors 105a-105b are depicted. Further, the two fiber optic DAS sensors 105a-105bare coupled together in daisy chain fashion.

As will be appreciated, the DAS sensor sonar system 100 is used to detect a position of the object 117 with respect to the watercraft 101. In particular, the processor 113 may comprise a DAS interrogator and a sonar signal processing system configured to perform beamforming and target acquisition processing on return optical signals from the plurality of DAS sensing panels 102a-102n.

Helpfully, the mandrel structure for each fiber optic DAS sensor 105a-105b may provide some operational benefits. For example, the DAS sensor sonar system 100 may rapidly change the operational frequency (i.e., scanning frequency) between wideband and narrowband modes while also providing signal gain.

In some embodiments, the detection of the object 117 may be entirely passive. In other words, the acoustic signal detected by the plurality of DAS sensing panels 102a-102n is generated by the object 117. In other applications, the detection of the object 117 may be active. In other words, the DAS sensor sonar system 100 may comprise an additional acoustic source device configured to generate an acoustic ping signal. The acoustic signal detected by the plurality of DAS sensing panels 102a-102n is generated from the object 117 and a return acoustic signal from the acoustic source signal.

Another aspect is directed to a watercraft 101 comprising a hull 103, and a DAS sensor sonar system 100 carried by the hull and comprising a plurality of DAS sensing panels 102a-102n for an exterior of the hull. The DAS sensor sonar system 100 also includes a plurality of arrays 104 of fiber optic DAS sensors 105a-105be respectively carried by the plurality of DAS sensing panels 102a-102n and coupled together in a daisy chain configuration. Each fiber optic DAS sensor 105a-105bd comprises a mandrel 114a-114b and an optical fiber 115a-115b wound thereon. The DAS sensor sonar system 100 also includes a DAS sonar device 106, and an optical fiber cable 107 for coupling a first fiber optic DAS sensor 105a and the DAS sonar device through a hull penetration 110 in the hull 103. Each of the mandrels 114a-114b has a set size, and the optical fibers 115a-115b have a prescribed number of turns around the mandrels. The number of turns for the optical fibers 115a-115band the size of the mandrels 114a-114b may depend on the operating frequency of the optical source 111. In some embodiments, the mandrels 114a-114b may each comprise a hollow mandrel.

Yet another aspect is directed to a method for installing a DAS sensor sonar system 100 in a watercraft 101. The method comprises positioning a plurality of DAS sensing panels 102a-102n on an exterior of a hull 103, and positioning a plurality of arrays 104 of fiber optic DAS sensors 105a-105be to be respectively carried by the plurality of DAS sensing panels and coupled together in a daisy chain configuration. Each fiber optic DAS sensor 105a-105bd includes a mandrel 114a-114b and an optical fiber 115a-115b wound thereon. The method further includes coupling an optical fiber cable 107 through a hull penetration 110 in the hull 103 and between a first fiber optic DAS sensor 105a and a DAS sonar device 106.

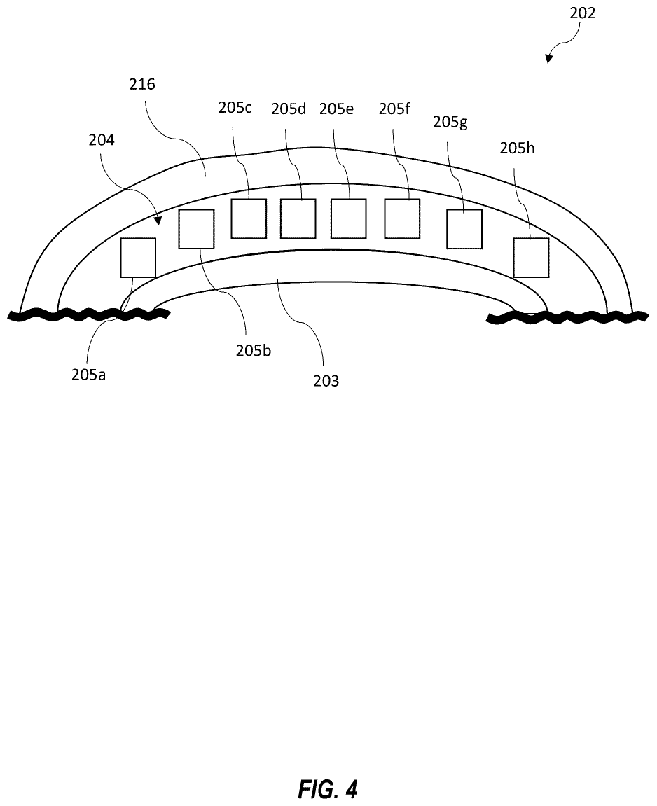

Referring now additionally to FIG. 4, another embodiment of the DAS sensing panel 202 is now described. In this embodiment of the DAS sensing panel 202, those elements already discussed above with respect to FIGS. 1-3 are incremented by 100 and most require no further discussion herein. This embodiment differs from the previous embodiment in that this DAS sensing panel 202 illustratively includes a curved shape conformal with adjacent portions of the watercraft 201. In other words, the DAS sensing panel 202 comprises a three-dimensional shape. The DAS sensing panel 202 illustratively includes a potting compound 216 over the array 204 of fiber optic DAS sensors 204a-204h. In some applications, the DAS sensing panel 202 may be carried by a bow and/or stern of watercraft (e.g., having a dome or pyramid shape).

Advantageously, the DAS sensor sonar system 100 may provide for several benefits over the existing approaches. For example, in typical approaches, watercraft may be outfitted with multiple subpanels on the hull, and may need as many as two to eight hull penetrations per panel for the needed fiber optic cables. In the DAS sensor sonar system 100, there is only one hull penetration 110 in the hull 103 of the watercraft 101. For underwater watercraft, this may be desirable and more dependable.

Further, in typical approaches, each subpanel has optical and electrical components. The electrical components must be protected from water intrusion using pressure vessels. In the DAS sensor sonar system 100, there are only optical components outside the hull 103, and there is no need for pressure vessels since all the electrical components are within the hull 103. In typical approaches, in addition to the multiple hull penetrations, the sonar system may require several optical sources, for example, as many as tens of optical sources in some applications (i.e., eight panel example, 8 columns per panel, 1 optical source per column). In the DAS sensor sonar system 100, the plurality of DAS sensing panels 102a-102n may be supported by a single optical source 111. In some applications, the optical source may be dedicated to a single DAS sensing panel, but that is still a significant reduction in the number of optical sources. This may reduce the weight of the watercraft 101.

In some approaches, large passive sonar panel technology may be used for underwater watercraft. A potential drawback to this approach is complexity of manufacturing. Helpfully, the DAS sensor sonar system 100 may provide for less costly manufacturing with the reduced number of optical sources.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A sonar system for a watercraft, the sonar system comprising:
at least one distributed acoustic sensing (DAS) sensing panel for an exterior of the watercraft;
an array of fiber optic DAS sensors carried by the at least one DAS sensing panel and coupled together in a daisy chain configuration, each fiber optic DAS sensor comprising a mandrel and an optical fiber wound thereon;
a DAS sonar device; and
an optical fiber cable for coupling a first fiber optic DAS sensor and the DAS sonar device through a hull penetration in the watercraft.

2. The sonar system of claim 1 wherein the at least one DAS sensing panel comprises a plurality thereof; and wherein the array of fiber optic DAS sensors comprises a plurality thereof respectively carried by the plurality of DAS sensing panels.

3. The sonar system of claim 1 wherein the at least one DAS sensing panel has a curved shape conformal with adjacent portions of the watercraft.

4. The sonar system of claim 1 comprising a potting compound over the array of fiber optic DAS sensors.

5. The sonar system of claim 1 wherein the array of fiber optic DAS sensors comprises at least two columns and at least two rows of DAS sensors.

6. The sonar system of claim 1 wherein the DAS sonar device comprises an optical source, an optical detector, and a processor coupled to the optical source and optical detector.

7. The sonar system of claim 1 wherein the DAS sonar device is entirely within the watercraft; and wherein the at least one DAS sensing panel does not include a pressure vessel.

8. A watercraft comprising:
a hull; and
a sonar system carried by the hull and comprising
at least one distributed acoustic sensing (DAS) sensing panel for an exterior of the hull,
an array of fiber optic DAS sensors carried by the at least one DAS sensing panel and coupled together in a daisy chain configuration, each fiber optic DAS sensor comprising a mandrel and an optical fiber wound thereon,
a DAS sonar device, and
an optical fiber cable for coupling a first fiber optic DAS sensor and the DAS sonar device through a hull penetration in the hull.

9. The watercraft of claim 8 wherein the at least one DAS sensing panel comprises a plurality thereof; and wherein the array of fiber optic DAS sensors comprises a plurality thereof respectively carried by the plurality of DAS sensing panels.

10. The watercraft of claim 8 wherein the at least one DAS sensing panel has a curved shape conformal with adjacent portions of the hull.

11. The watercraft of claim 8 wherein the sonar system comprises a potting compound over the array of fiber optic DAS sensors.

12. The watercraft of claim 8 wherein the array of fiber optic DAS sensors comprises at least two columns and at least two rows of DAS sensors.

13. The watercraft of claim 8 wherein the DAS sonar device comprises an optical source, an optical detector, and a processor coupled to the optical source and optical detector.

14. The watercraft of claim 8 wherein the DAS sonar device is entirely within the watercraft; and wherein the at least one DAS sensing panel does not include a pressure vessel.

15. A method for installing a sonar system in a watercraft, the method comprising:
positioning at least one distributed acoustic sensing (DAS) sensing panel on an exterior of a hull;
positioning an array of fiber optic DAS sensors to be carried by the at least one DAS sensing panel and coupled together in a daisy chain configuration, each fiber optic DAS sensor comprising a mandrel and an optical fiber wound thereon; and
coupling an optical fiber cable through a hull penetration in the hull and between a first fiber optic DAS sensor and a DAS sonar device.

16. The method of claim 15 wherein the at least one DAS sensing panel comprises a plurality thereof; and wherein the array of fiber optic DAS sensors comprises a plurality thereof respectively carried by the plurality of DAS sensing panels.

17. The method of claim 15 wherein the at least one DAS sensing panel has a curved shape conformal with adjacent portions of the hull.

18. The method of claim 15 wherein the sonar system comprises a potting compound over the array of fiber optic DAS sensors.

19. The method of claim 15 wherein the array of fiber optic DAS sensors comprises at least two columns and at least two rows of DAS sensors.

20. The method of claim 15 wherein the DAS sonar device comprises an optical source, an optical detector, and a processor coupled to the optical source and optical detector.
